(19) United States
(12) Patent Application Publication
(10) Pub. No.: US 2005/0138794 A1
(43) Pub. Date: Jun. 30, 2005

(54) Suspension assembly method and the manufacture process

(76) Inventors: Ming Gao Yao, Dongguan City (CN); Masashi Shiraishi, Kowloon (HK)

Correspondence Address: KENYON & KENYON, Suite 600, 333 W. San Carlos, San Jose, CA, 95110-2711, US

(21) Appl. No.: 10/997,183

(22) Filed: Nov. 24, 2004

(30) Foreign Application Priority Data
Dec. 29, 2003 (WO) PCT/CN03/01139

(51) Int. Cl. G11B 5/127; H04R 31/00

(52) U.S. Cl. 29/603.03; 29/831

(57) ABSTRACT

A method of manufacturing a flexible printed circuit suspension assembly is disclosed. Specifically, the method comprises attaching a suspension to a first end of a flexible printed circuit, bending the suspension to a predetermined position to form a gram load, and attaching the suspension to a second end of the flexible printed circuit. The first end of the flexible printed circuit may be the top end of the flexible printed circuit to be attached to the top end of the suspension, while the second end may be the tail end of the flexible printed circuit to be attached to the flexible printed circuit holder of the suspension.

### FIELD OF THE INVENTION

The present invention relates to the assembly of disk drives. More specifically, the present invention relates to manufacturing the Flexible printed circuit (FPC) Suspension Assembly (FSA) so as to prevent the deformation and misalignment of the apparatus during assembly.

### BACKGROUND OF THE INVENTION

In the disk drive industry today, different methods are used to manufacture head suspensions. Two traditional methods are the trace suspension assembly (TSA) and the printed circle in suspension (CIS). The TSA method utilizes a laminate of a resilient material layer such as stainless steel, an insulating material such as a polyimide, and a conductive layer such as copper. The insulating layer is later to be removed by an etching process. The CIS method utilizes a laminate of a patterned insulating layer (such as a photosensitive polyimide) on a resilient material layer such as stainless steel. A conductive layer is then formed on the insulating layer by a process such as plating. Due to cost considerations, the aforementioned methods are not optimal for today's industry requirements. A new more cost-efficient method of manufacture is necessary.

One methodology called the FPC suspension assembly (FSA) has been developed and is described in patent JP 2000-100142, shown in FIG. 1. FIG. 1 shows a head slider 106 physically and electrically bonded to an insulated flexible print circuit unit 101 and structure 103. There are four electric bonding sites 110 that are electrically connected to the head slider and testing sites (or pads) 104 through traces 107 and 108. Two parts of the suspension body 102 and 105 are coupled together to create a forming angle. The FPC with the head slider and the structure are then bonded to the two parts of the suspension body.

FIG. 2 shows a flexible print circuit deformation problem that is characteristic of the prior art methodology. The vacuum nozzle (or holder) 201 will pick up the flexible print circuit 101 in order to attach it to the suspension body parts 102 and 105. When the vacuum nozzle picks up one end of the flexible print circuit, it deforms the opposing end due to its weight. This creates corresponding difficulties in the attachment process.

FIG. 3 shows another problem inherent in the prior art in attaching the FPC to the suspension body. When the head slider is flying over the disk, the air pressure generated by the flight can often push the head slider away from the disk. A gram load can be used to counterbalance this force and maintain the head's flying stability. FIG. 3a is an illustration of the prior art that shows suspension body or suspension body parts 102 and 105 including forming angle 301. The forming angle is used to maintain the gram-load when air pressure is exerted on the suspension structure (not shown). This angle also maintains an offset between the suspension load beam and rotating disk surface.

In the prior art design the suspension and the FPC are manufactured in a manner that prevents them from being attached completely, thereby creating a space between the FPC and the suspension base. In this case, the process of laminating the insulated strip material to smoothly form an angle with the material surface is problematic because it is difficult to both maintain the soft insulated strip material flat and preserve its structural integrity. Furthermore, it is difficult to create a smooth coupling between the soft strip material and the stainless steel material surface using this process without changing the forming angle. It is also impossible to mass-produce disk drives with sufficient capability and high yields. In FIG. 3b, shows a prior art design manufactured in such a manner that FPC 101 does not line up with both side surfaces of the suspension body parts (102 and 105), thereby creating a space between the two and a small attachment angle 303 on both sides between the FPC and the suspension body parts. This is difficult to prevent since adding pressure to the laminate may damage the forming angle. Also, if the small attachment angle remains, reliability of the apparatus becomes a major concern. For example, during an ambient condition change (temperature or humidity), the FPC may shrink more than the suspension (since the coefficient of thermal expansion of the FPC and stainless steel are different). This may lead to a change in the load gram load of the suspension body, cracking of the FPC or the detachment of the FPC from the suspension, thereby affecting the overall stability of the head suspension.

Therefore, there is a need in the disk drive industry for a design method that properly handles the FPC strip to prevent deformation and avoids the difficulties of attaching the FPC to the suspension (i.e., the first and second support materials 102 and 105). Also, it is desirable to have a cost-efficient method that is capable of withstanding changes in the ambient conditions surrounding the disk drive elements so as to enhance long-term reliability.

### BRIEF DESCRIPTION OF THE DRAWINGS

FIG. 1 shows an exploded view of a hard disk drive as in the prior art, including a head suspension assembly.

FIG. 2 shows an exploded view of the soft FPC deformation problem.

FIGS. 3a-b shows a perspective view of the problems surrounding the creation of the formation angle by the attachment of the FPC to the suspension body.

FIGS. 4a-f show exploded and perspective views detailing an embodiment of the present invention.

FIGS. 5a-n show exploded and perspective views detailing the method of present invention.

FIG. 6 shows a flowchart detailing the method of manufacturing the present invention.

### DETAILED DESCRIPTION

A Flexible printed circuit (FPC) Suspension Assembly (FSA) capable of resisting deformation or misalignment during assembly and a method of manufacturing such an assembly are disclosed.

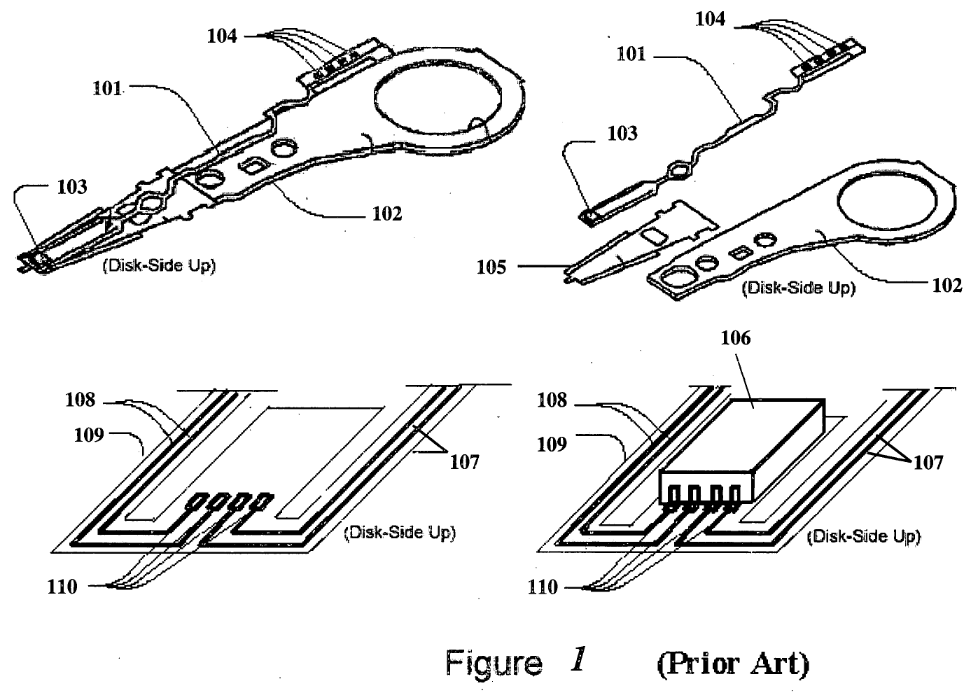

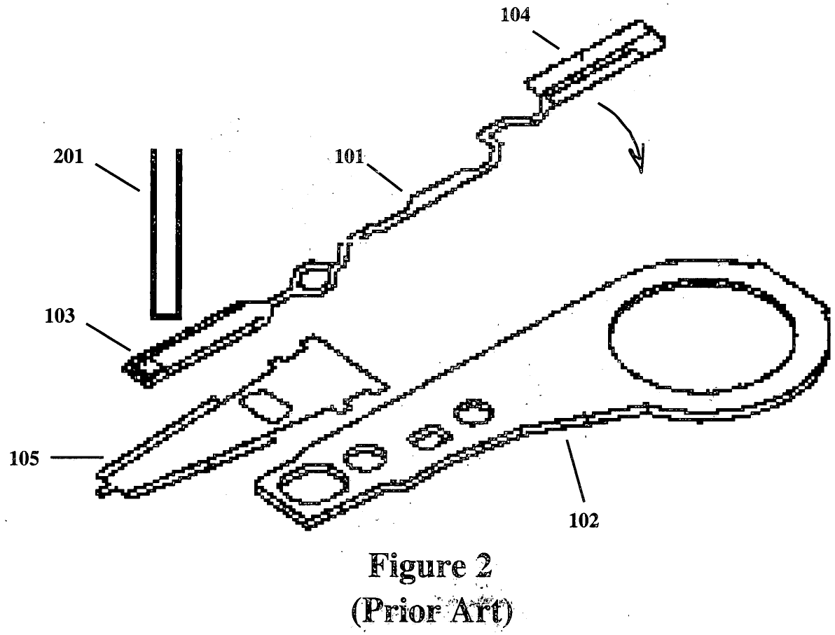

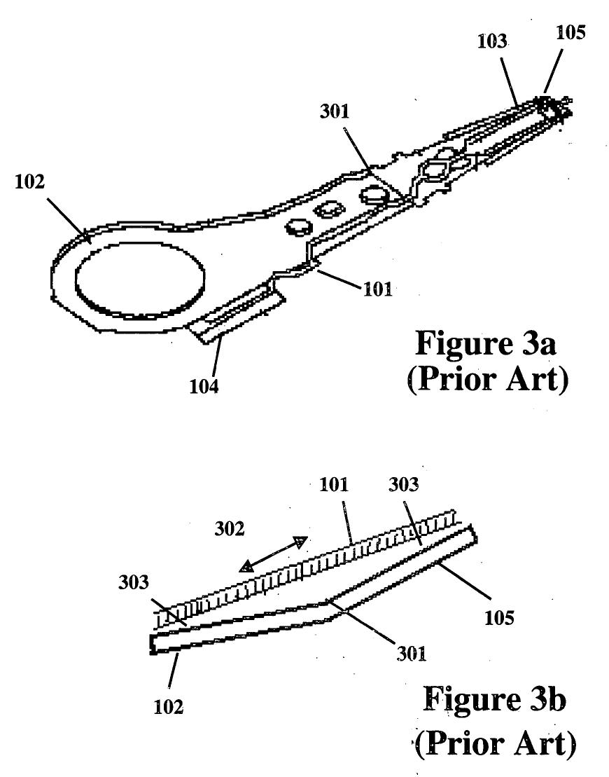

FIG. 1 shows an exploded view of a hard disk drive as in the prior art, including a head suspension assembly (discussed above). FIG. 2 shows an exploded view of the soft FPC deformation problem (discussed above). FIGS. 3a-b shows a perspective view of the problems surrounding the creation of the formation angle by the attachment of the FPC to the suspension body (discussed above).

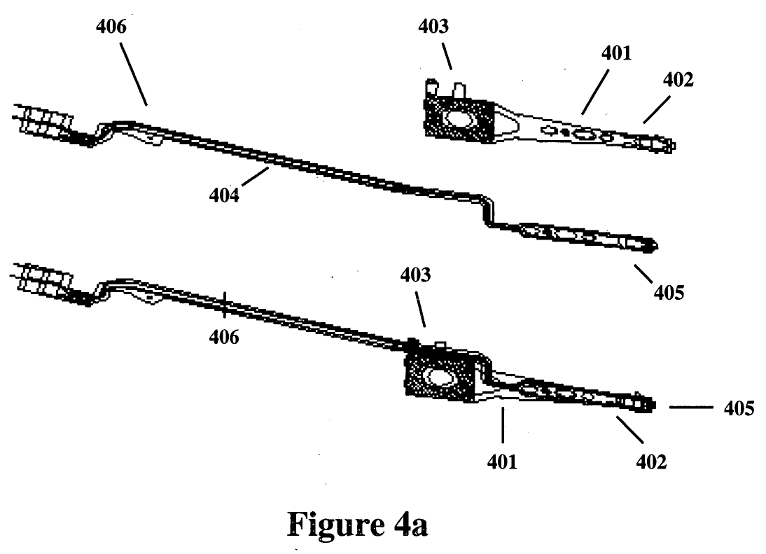

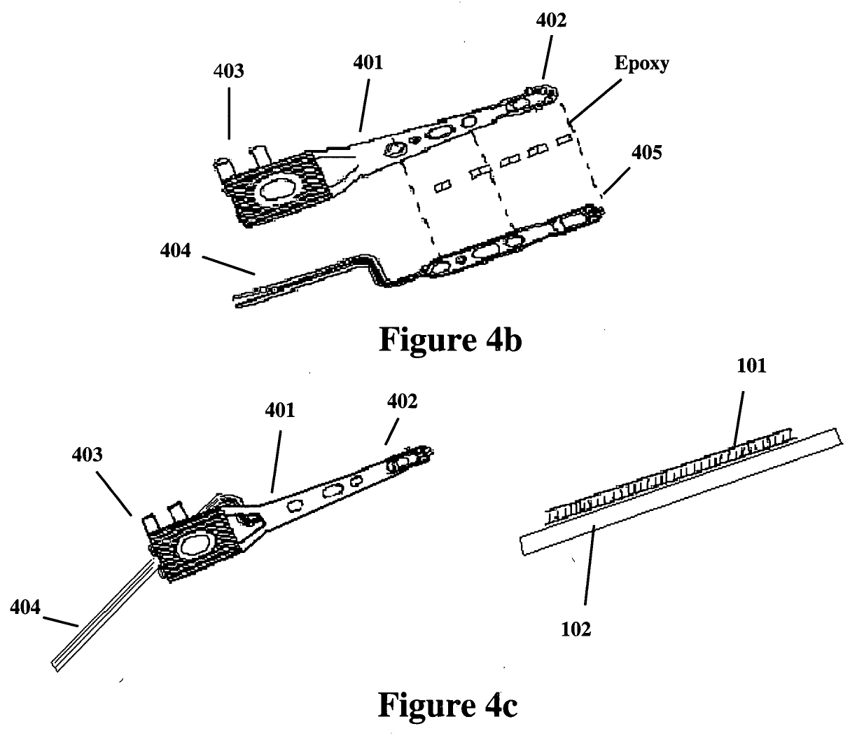

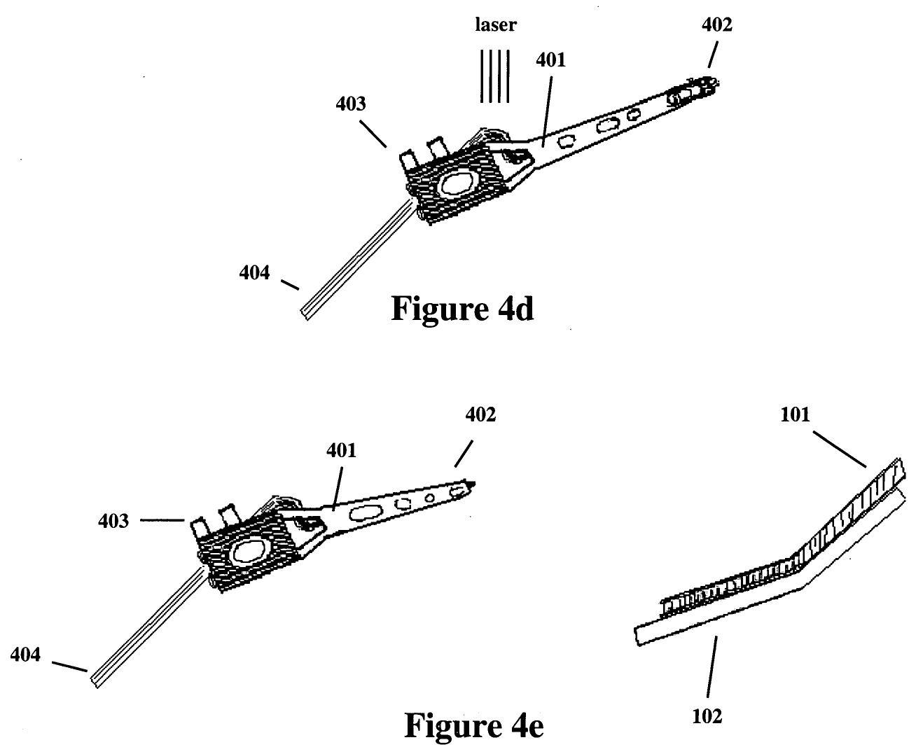

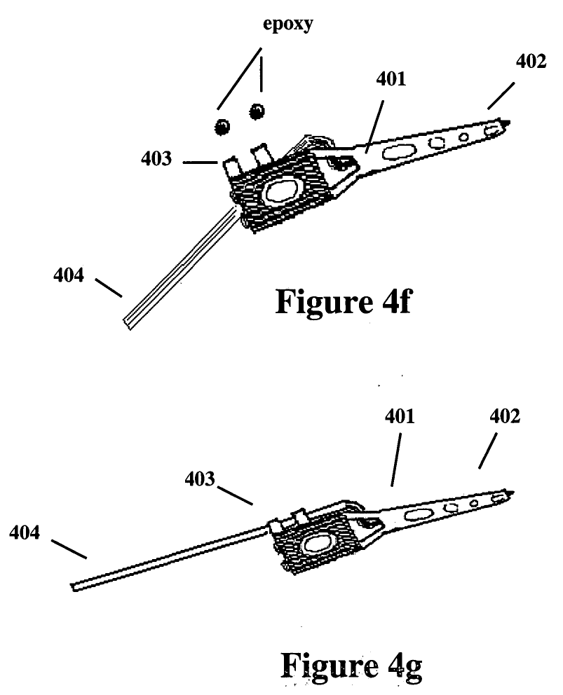

FIG. 4 illustrates an embodiment of the present invention. FIG. 4a shows a suspension body (which may be made of stainless steel) 401 having a top end 402 (the suspension structure) and other end 403 (the flexible printed circuit (FPC) holder). FPC 404 has a top end 405 and a tail end 406. In this embodiment, the suspension body is then attached to the FPC in a manner so that the suspension structure top end attached directly along the surface of the top end of the flexible printed circuit. This design eliminates the space between the FPC and the suspension and the creation of a forming angle discussed above, thereby alleviates the problems such as cracking and separation. FIG. 4b shows an attachment process used to attach the FPC to the suspension mass. In order to facilitate the proper fitting of the FPC with the suspension body, there are alignment holes (tooling holes) 407 in the suspension body and alignment holes 408 in the FPC. These holes are used as the datum for the attachment. The use of these alignment holes in this mounting procedure allows for the simple, trouble-free attachment of the suspension body to the FPC. Epoxy is used for the mounting process. FIG. 4c shows the FPC and the suspension after attachment.

FIG. 4d shows a gram load forming process using a laser beam 409. Since the FPC has been attached along the surface of the suspension, the laser beam can then be used to form the gram load at the suspension assembly gram load position 410, creating the appropriate forming angle. FIG. 4e shows the suspension after the laser forming process (including the gram load). FIG. 4f shows epoxy being used by placing to epoxy points to facilitate the mounting of the FPC to the FPC holder of the suspension. The epoxy is then used to mount the FPC to the FPC holder at the epoxy points. FIG. 4g shows a view after the mounting of the FPC to the FPC holder of the suspension.

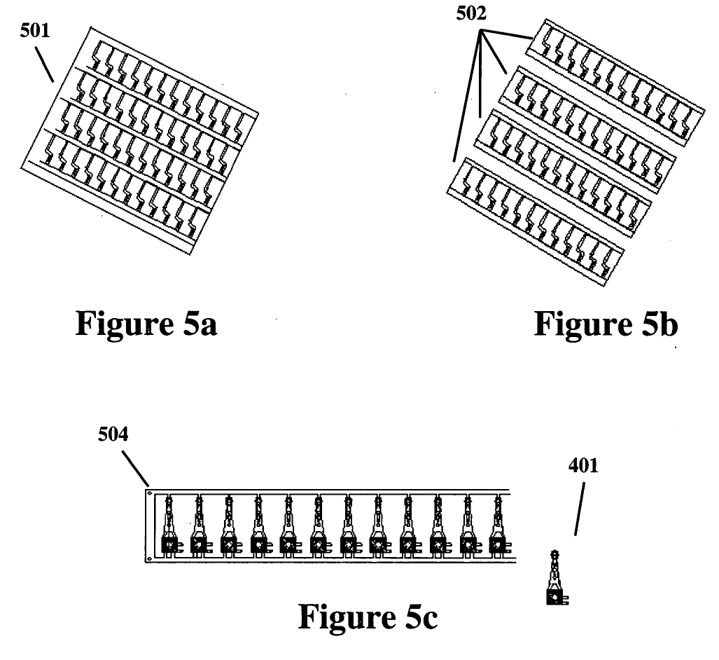

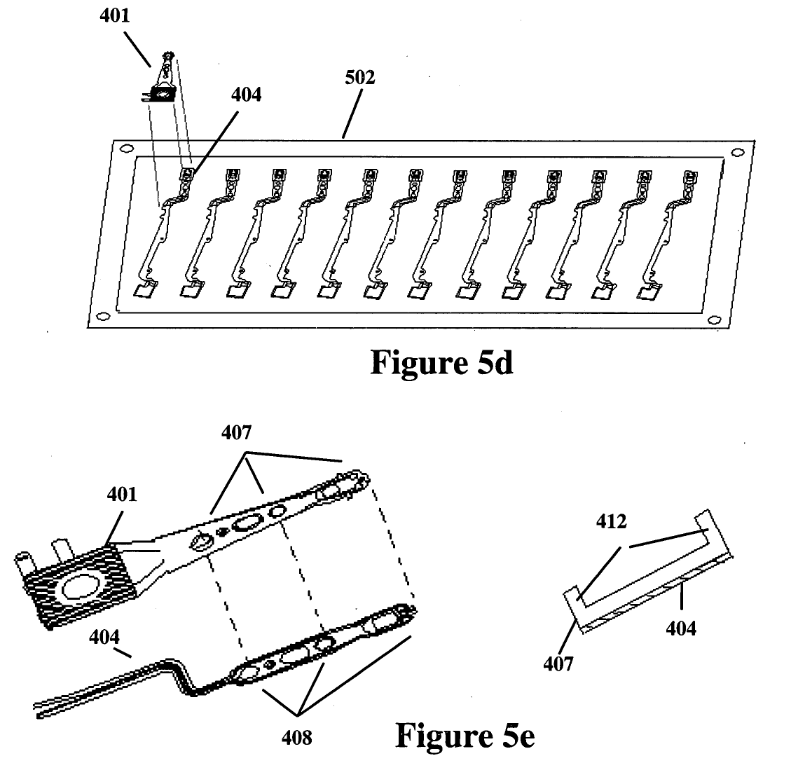

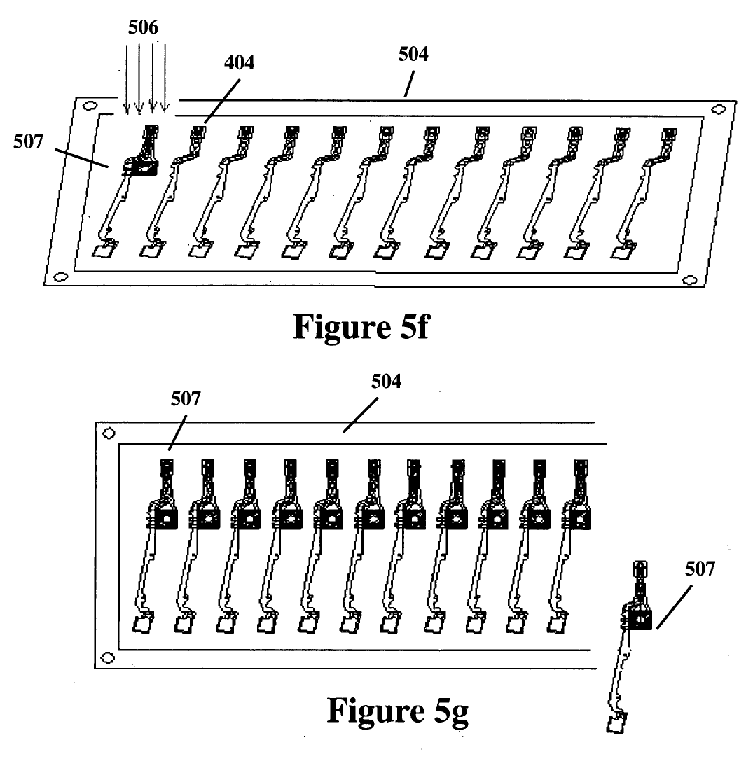

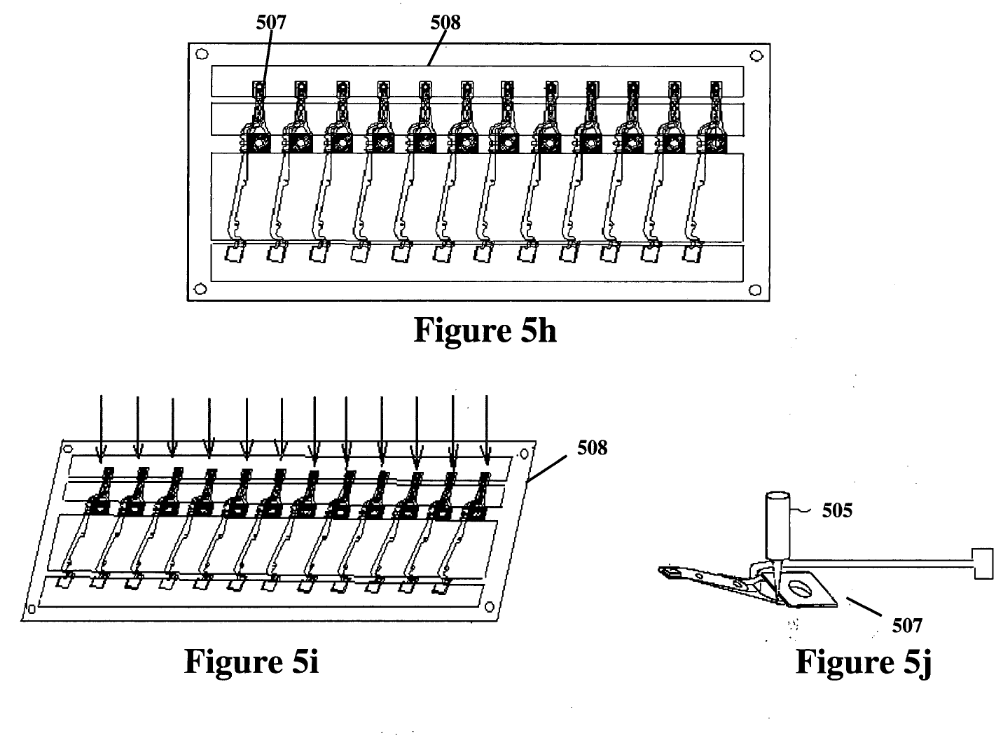

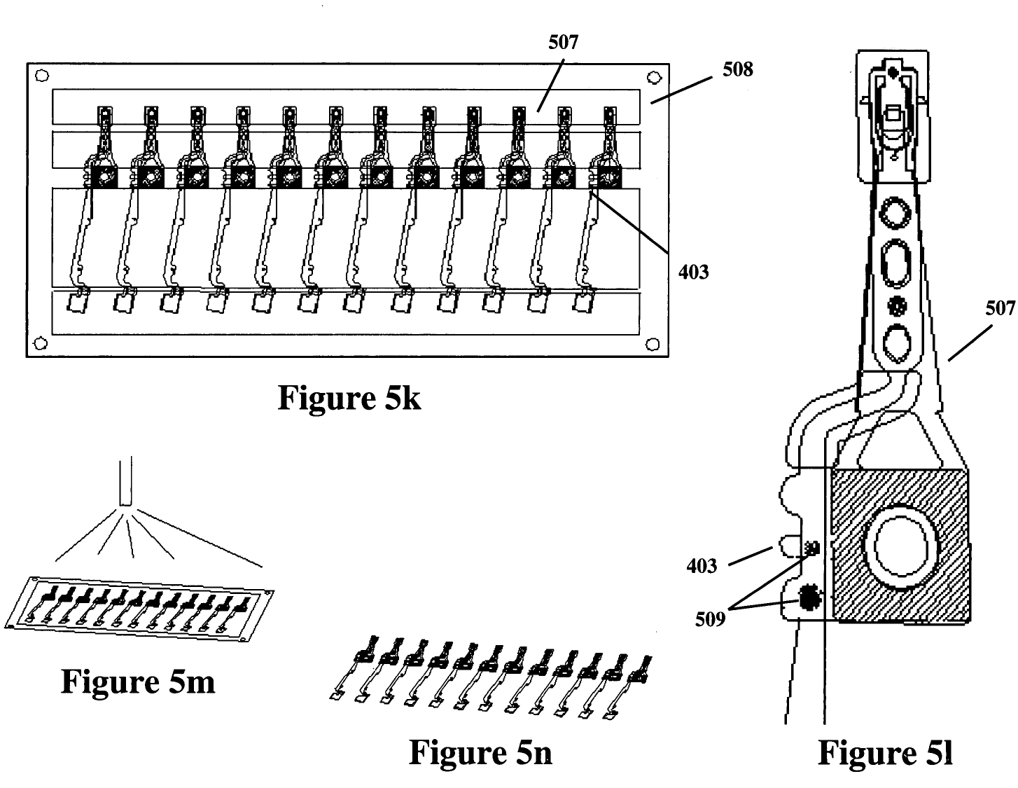

FIG. 5 shows an embodiment of the manufacturing process of this invention. FIG. 5a shows a green sheet 501 of the flexible printed circuits. The sheet is comprised of multiple strips, which in turn each have multiple single FPC units. FIG. 5b shows the single strips of FPC 502 that have been cut from the green sheet after a cutting process. FIG. 5c shows a cutting process of the strip of suspension bodies 504 to single suspension bodies 401. An attachment process is shown in FIG. 5d. In this embodiment, an automated machine can be used to attach the single suspension bodies to the fixed FPC sheet unit one by one. FIG. 5e shows the attachment of the single suspension body to FPC unit 404 as discussed above. There are three alignment or tooling holes 407 in the suspension body and there are three alignment or tooling holes 408 in the FPC unit. Pins, or the like, may be inserted into the alignment holes to control the relative positioning of the suspension body and the FPC unit. An automated machine may use a camera system to automatically detect the location of the hole of the FPC and attach the suspension accordingly. The cross section view of FIG. 5e shows the flexible printed circuit 404 which is attached on opposing rail edges 412 of the suspension 401. In this embodiment, the suspension is made of stainless steel. In FIG. 5f, in example of a UV (ultraviolet) curing process is shown. In this embodiment, UV epoxy is used for mounting the suspension unit and the FPC unit (as discussed above). The UV light 506 can be used for the epoxy curing. FIG. 5g shows an example of a cutting process. In this embodiment, once the attachment and the UV curing have been completed, a cutter (not shown) is used to sever individual flexible printed circuit) suspension assemblies 507. FIG. 5h shows the loading of all of the severed individual FPC suspension assemblies onto a loading fixture, forming fixture, or holder 508. FIG. 5i shows a laser forming process where laser light is used to heat the assembly at a gram load position to form the gram load. FIG. 5j shows a detailed view of the forming process. In this embodiment, a laser beam 505 is used to heat the gram load position of the FPC suspension assembly unit. FIG. 5k shows mounting the tail of the flexible printed circuit and suspension FPC holder process in a load fixture after the laser forming in FIG. 5j. FIG. 5l shows a detailed view of this bonding. Two epoxy points 509 may be added in either the suspension holder or the tail of the flexible printed circuit surface to make this bonding (as discussed above). FIG. 5m shows a final curing process after bonding the tail of the flexible printed circuit to the suspension holder. This process is also used to stabilize the gram load/static attitude performance. After the final curing process, the suspension assemblies are unloaded (see FIG. 5n) for further assembly (e.g., for head gimbal assembly and head stack assembly, or into a disk drive apparatus).

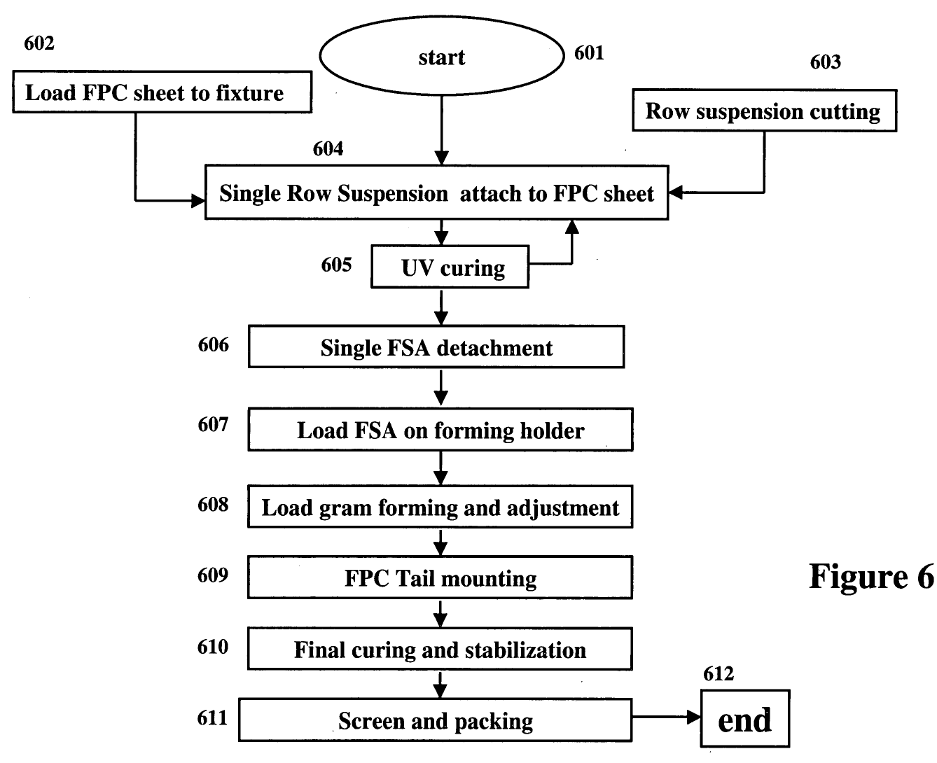

FIG. 6 shows the process detailing an embodiment of the present invention. In 602, the FPC sheet is loaded on a fixture. In 603, suspensions are cut from the strip into single units. In 604, single suspension units are attached to the FPC's on the FPC sheet one by one. In process 605, UV light is used for epoxy curing. In process 606, the single unit FPC suspension assemblies are detached from the strip. In process 607, the single FPC suspension assembly is loaded onto a forming fixture or holder. Next, laser forming is used to generate the appropriate gram load in step 608. In process 609, the FPC tail is bonded to the suspension FPC holder. The process 610 is used to cure the epoxy with UV and stabilize the gram load and static attitude. Process 611 is used for screening and packaging.

1. A method of manufacturing a flexible printed circuit suspension assembly comprising:
attaching a suspension to a first end of a flexible printed circuit;
bending the suspension to a predetermined position to form a gram load; and
attaching the suspension to a second end of the flexible printed circuit.

2. The method of claim 1, wherein the suspension is attached along the surface of the first end of the flexible printed circuit.

3. The method of claim 1, wherein the first end of the flexible printed circuit is the top end of the flexible printed circuit.

4. The method of claim 3, wherein the top end of the flexible printed circuit is attached to the top end of the suspension.

5. The method of claim 1,wherein the second end of the flexible printed circuit is the tail end of the flexible printed circuit

6. The method of claim 5, wherein the tail end of the flexible printed circuit is attached to the flexible printed circuit holder of the suspension.

7. The method of claim 1, wherein the first end of the flexible printed circuit is attached to the suspension using alignment holes to ascertain the attaching position.

8. The method of claim 7, wherein pins are inserted through the alignment holes to maintain the positioning of the suspension and the FPC.

9. The method of claim 1, wherein a laser is used to generate the gram load.

10. The method of claim 9, wherein the laser heats the gram load position to form the gram load.

11. The method of claim 1, wherein ultraviolet curing is used to attach the first end and the second end of the flexible printed circuit to the suspension.
